(19) United States
(12) Patent Application Publication
(10) Pub. No.: US 2016/0186792 A1
(43) Pub. Date: Jun. 30, 2016

(54) CONNECTION ASSEMBLY WITH BAYONET LOCKING OF THE CONNECTION ELEMENTS

(71) Applicant: RADIALL, Aubervilliers (FR)

(72) Inventor: Laurent VALENCIA, Saint Genix Sur Guiers (FR)

(73) Assignee: RADIALL, Aubervilliers (FR)

(21) Appl. No.: 14/980,783

(22) Filed: Dec. 28, 2015

(30) Foreign Application Priority Data
Dec. 24, 2014 (FR) 14 63313

(51) Int. Cl. F16B 7/20; F16B 7/04

(52) U.S. Cl. CPC F16B 7/20; F16B 7/0406

(57) ABSTRACT

A connection assembly with bayonet locking of the connection elements. In accordance with this disclosure, there is provided a part for immobilizing the locking element of the bayonet system against movement in translation in the position of mutual locking, the immobilizing part being removably placed on the body carrying the bayonet lug.

### FIELD OF THE INVENTION

The present invention concerns the field of connection assemblies including a first connection element and a second connection element adapted to be locked together by a bayonet locking system.

The invention applies more particularly to optical contact connection assemblies. The invention may for example be applied to a connection assembly with an optical contact element and to its optical connector or to an optical socket.

The invention may be applied in particular to a connection assembly with a plug including at least one contact connected to a cable and an open body inside which the contact or contacts is or are received and with a socket with a plate for fixing it to a panel of a user equipment, the plug and the socket being locked to each other by a bayonet system, for example as described in the patent EP 2239605 B1.

However, the invention is not limited to optical connection assemblies and applies to all those in which the mutual locking between the connection elements is effected by a bayonet system.

Accordingly, the invention may be applied to an electrical connection assembly, notably a coaxial connection assembly including a male coaxial connector and a female coaxial connector, each of the male and female connectors including a central contact and a ground contact consisting of a metal body of tubular general shape arranged around the central contact. One of the elements may be an adapter.

The invention may equally be applied to an electrical or optical contact engaged in a cavity of the insert of a multi-contact connector.

The invention may be applied to any connection assembly for cables including a plurality of electrical conductors, notably for twinaxial or quadri-axial cables.

### PRIOR ART

Connection assemblies include a first connection element and a second connection element adapted to be engaged in the first, in order to provide continuity for the (electrical, microwave, optical, etc.) signal transmitted between two cables.

It is known to be able to lock the connection elements to each other, once the connection has been made, by a bayonet fixing system, in order to prevent their unintended separation linked to operation (vibration, etc.) or inherent to the installations in which the connection assemblies are installed.

Bayonet systems generally consist of one or more, typically two or three, locking pins or lugs at the periphery of the ground contact of one of the elements and a female locking element, referred to as the locking cap or bush, mounted at least to be free to rotate about the ground contact of the other of the connection elements. The locking cap is adapted to be held in the hand and includes a portion provided with one or more, typically two or three, locking grooves or ramps.

The shape and the arrangement of each locking groove are such that each locking pin can penetrate into it by movement in translation of the locking cap and thereafter rotation of the latter about the ground contact carrying the pin(s) effects the mutual mechanical locking between the male and female connectors.

In some of these connection assemblies, there may further be provided a coil spring that makes it possible to push the locking cap in the direction opposite that of introduction of the pin(s) into the groove and thereby to maintain the locking of the cap around the pin(s).

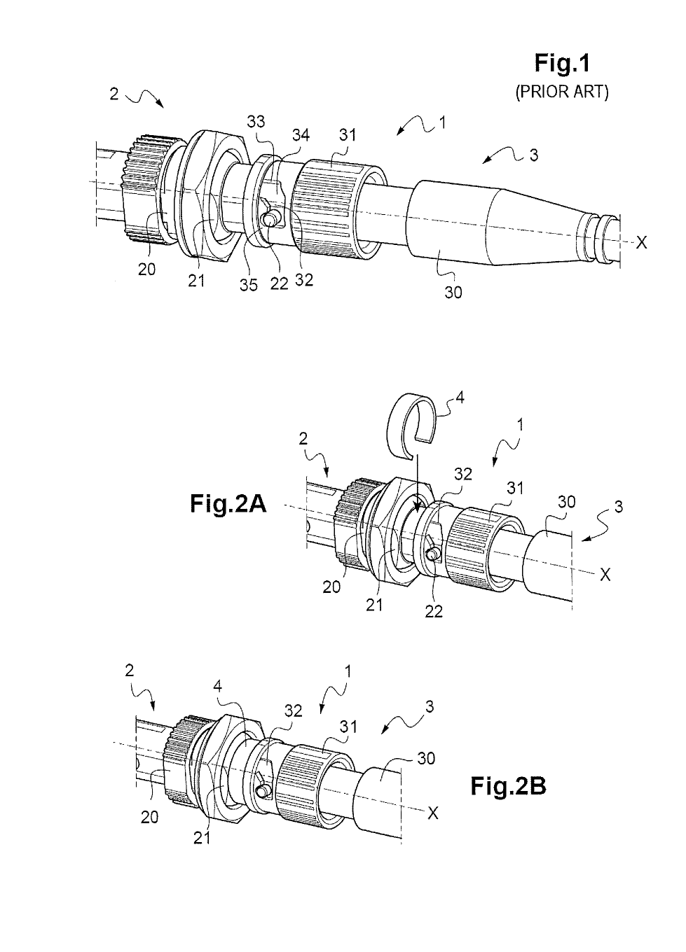

There may be cited here the optical connection assemblies marketed by the company RADIALL under the designation ST (Standard Tip), which include a bayonet locking system. Such an optical connection assembly 1 is represented in FIG. 1 in a locked connection configuration and includes a connector 2 engaged in a connector 3.

The connector 2 includes a body 20 with a portion forming a connector 21 at the periphery of which there is a locking lug or pin 22.

The connector 3 includes a body 30 around which is mounted so as to be free to move in translation and in rotation a female locking cap 31 in which there is an outwardly open groove 32. The open groove 32 includes a first rectilinear portion 33 opening onto the outside of the cap, an inclined portion 34 in line with the first rectilinear portion 33, and finally a second rectilinear portion 35 in line with the inclined portion 33. Here the portions 33 and 35 are rectilinear along the axis of movement in translation of the cap 31 and the inclined portion 34 extends transversely to the portions 33 and 35.

The bayonet locking between the connector 2 and the connector 3, once they are mutually connected, is achieved in the following manner.

An operator causes the cap 31 to slide on the connector 21 with the groove 32 aligned with the lug 22. Once the lug 22 abuts against the end of the first rectilinear portion 33, the operator applies a rotation to the cap 31, which causes the lug 22 to move into the inclined portion 34 and to lodge in the second rectilinear portion 35. The locking as such is therefore effected by the lodging or in other words trapping of the lug 22 in the portion 35 of the groove 32.

Because it must be possible for the locking cap to be manipulated by hand, the force that is applied to effect the actual locking by movement in translation and then in rotation of the cap is relatively small. Accordingly, in some circumstances linked to the operation or to the installations, it has proven that, when subjected to high vibrations, some bayonet locking coaxial connection assemblies as described above could become unlocked by the force resulting from the strong vibrations alone.

Patent application EP0660452 discloses a connection assembly with bayonet fixing of a male connector to a panel by means of two removable parts one of which is open and carries a locking lug that lodges in a groove on a projecting part of the panel and the other of which closes the open part in order to prevent access to this locking system, this closing part moreover attaching to the panel, This solution has the disadvantage of a large number of parts that can easily be lost.

Patent EP1154169B1 proposes, in a coaxial connection assembly, producing a cap with a tab defining a locking groove, which is elastic, and inserting a removable additional locking part in a portion of the groove accommodating a locking lug, the insertion being made possible by elastic deformation of the tab. This solution firstly has the serious disadvantage of including an additional locking part the shape of which is complicated to produce and that is not robust. Then, the dimensional accuracies that it is necessary to achieve on the tab and the locking part are high.

Whatever the efficacy of the known bayonet locking systems, there remains a risk of accidental disassembling thereof during manual manipulations by an operator or manipulations using a tool, more particularly when working blind or in a cluttered environment. This is even more critical if the installations necessitate twisting of cables as is the case in multi-contact connectors with fibres fastened to the part with the lugs.

The rotation immobilizing means of the bayonet system described in patent application EP0660452 and patent EP1154169B1 also do not prevent unintended disassembling. They moreover have the major disadvantage of greatly increasing the overall size of the connection assembly in the radial direction since they are added on the outside and exceed the dimensioning diameter of one or the other of the male and female connection elements. Now, a large overall size of the immobilizing means in the radial direction may be problematic or even unacceptable in some applications, notably where it is required to provide a seal by means of a sleeve that is intended to cap, i.e. to cover the locking cap as closely as possible in order to leave the minimum gap in order to guarantee the required seal.

There is therefore a requirement to improve bayonet locking connection assemblies, notably in order to avoid all risk of accidental unlocking by an operator, either manually or using a tool, without increasing its overall size in the radial direction.

The object of the invention is to address this requirement at least in part.

### SUMMARY OF THE INVENTION

To this end the invention concerns a connection assembly including:

a first connection element,

a second connection element,

a system for mutual locking of the first and second connection elements, the system including at least one locking lug at the periphery of the body of one of the first and second connection elements and a locking element integral to the other of the first and second connection elements, including at least one locking groove the shape and the arrangement of which are such that the lug can penetrate into it by movement in translation relative to the lug of the locking element and thereafter rotation of the latter around the body carrying the lug effects the mutual locking.

Moreover, the movement in translation of the lug of the locking element in the locking groove is effected in a direction of connection of the first and second connection elements and the rotation of the locking element around the body carrying the lug is followed by a second movement in translation of the lug in the locking groove in a direction of disconnection of the first and second connection elements that brings the locking element into the position of mutual locking.

In accordance with the invention, the connection assembly further includes a part for immobilizing the locking element against movement in translation in the position of mutual locking, the locking part being removably placed on the body carrying the lug.

Accordingly, in accordance with one aspect of the invention, the immobilizing part is adapted to immobilize the locking element against movement in translation in a direction of connection of the first and second connection elements.

The immobilization of the locking element against movement in translation in a disconnection direction is effected by virtue of the lug of the locking element abutting against an abutment portion of the locking groove.

In accordance with one advantageous embodiment, when it is in its immobilizing position, the part does not project beyond the dimensioning diameter of the locking system.

In accordance with this embodiment, the immobilizing part does not project beyond the largest outside diameter Ø of the locking element.

Thanks to the part for immobilizing the locking element against movement in translation, the invention makes it possible to prevent all risk of accidental unlocking and therefore of accidental disconnection by an operator, notably when working blind or in a cluttered environment.

The immobilizing solution in accordance with the invention is simple to implement and of low cost.

Unlike the known immobilizing solutions, such as those described in patent application EP0660452 and patent EP1154169B1, the invention makes it possible to obtain a robust immobilizing part that is easy to manufacture and to install and that additionally has the advantage of a small overall size in the radial direction.

The small overall size in the radial direction of the immobilizing part in accordance with the invention is particularly advantageous when it is required to confer a sealing function on the connection assembly, without increasing the dimensions of the sealing elements. Indeed, because this part does not project from the dimensioning diameter of the locking system, it is possible for example to use a sealing sleeve of standard size that caps the locking element, for example a locking cap.

In accordance with a first advantageous embodiment, the locking part is an elastic ring mounted directly or indirectly on a cylindrical bearing surface of the body carrying the lug.

In accordance with this first embodiment, the elastic ring may advantageously be mounted in a groove of the body carrying the lug.

In a variant assembly, the elastic ring is mounted perpendicularly to the axis of the connection.

In accordance with a first variant embodiment, the elastic ring is a snap ring of constant section. The snap ring of constant section may further include lodged in the portion of the locking groove in which the lug is inserted during the movement in translation of the locking element and that is open to the outside.

In accordance with a second variant embodiment, the elastic ring is a ring of non-constant section, preferably a ring of crescent shape type.

In accordance with a second advantageous embodiment, the immobilizing part is a nut the interior thread of which is screwed onto the exterior thread of the body carrying the lug.

The connection assembly in accordance with the invention may have one of the first and second connection element of female type, whereas the other is of male type, adapted to be connected to the female connection element, and the locking element constituting a cap mounted to move freely in rotation and in translation around the body of one of the female or male connection elements.

The connection assembly may constitute a coaxial connection assembly, intended to connect two coaxial cables to each other, each of the connection elements constituting a coaxial connector.

One of the connection elements may constitute a part of a multi-contact connector whereas the other element carrying the locking lug constitutes an optical contact element of the connector.

The connection assembly may constitute a connection assembly with electrical and/or optical contacts.

The invention also consists in a method of assembling two connection elements, respectively male and female, of a connection assembly further including a system for locking the connection elements in a configuration connected to each other, the system including at least one locking lug at the periphery of the body of one of the male or female connection elements, and a locking element, referred to as the locking cap, mounted so as to be free to rotate and around the body of the other of the connection elements, and including at least one locking groove, the method including the following steps:

connecting the connection elements to each other

mutual locking of the elements in their connected configuration by movement in translation of the cap so that the lug can penetrate into the groove by movement in translation of the cap followed by rotation thereof about the body carrying the lug,

removably placing an immobilizing part on the body carrying the lug so that it immobilizes the cap against movement in translation in the position of mutual locking.

Finally, the invention consists in a method of disassembling two connection elements, respectively male and female, of a connection assembly further including a system for locking the connection elements in a configuration connected to each other, the system including at least one locking lug at the periphery of the body of one of the connection elements, and a locking element, referred to as the locking cap, mounted so as to be free to rotate and around the body of the other of the connection elements, and including at least one locking groove, the method including the following steps:

removing a removable immobilizing part on the body carrying the lug from its immobilizing position in which it immobilizes the cap against movement in translation in the position of mutual locking of the elements,

mutual unlocking of the elements in their connected configuration by rotation of the cap about the body carrying the lug followed by movement in translation such that the lug can be extracted from the groove,

disconnecting the connection elements from each other.

### DETAILED DESCRIPTION

Other advantages and features of the invention will become apparent on reading the following description of one nonlimiting embodiment with reference to the appended drawings, in which:

FIG. 1 is a perspective view of a prior art coaxial connection assembly in its connected and locked configuration,

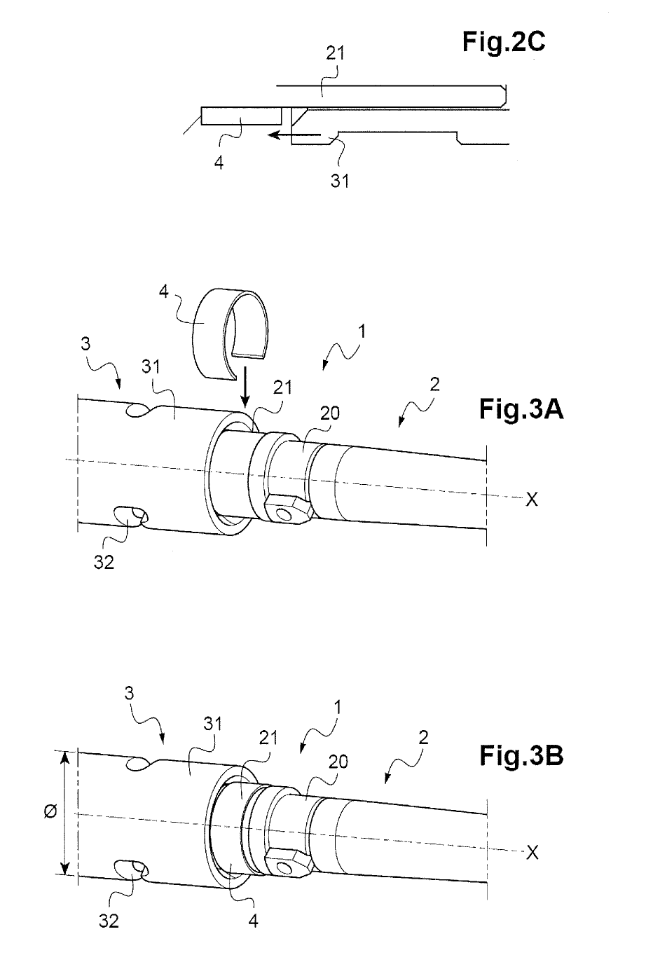

FIGS. 2A and 2B are perspective views showing the step of placing an immobilizing part in accordance with a first variant of the invention on an assembly according to FIG. 1,

FIG. 2C is a sectional detail view of FIG. 2B,

FIGS. 3A and 3B are perspective views showing the step of placing an immobilizing part in accordance with the first variant of the invention on another connection assembly,

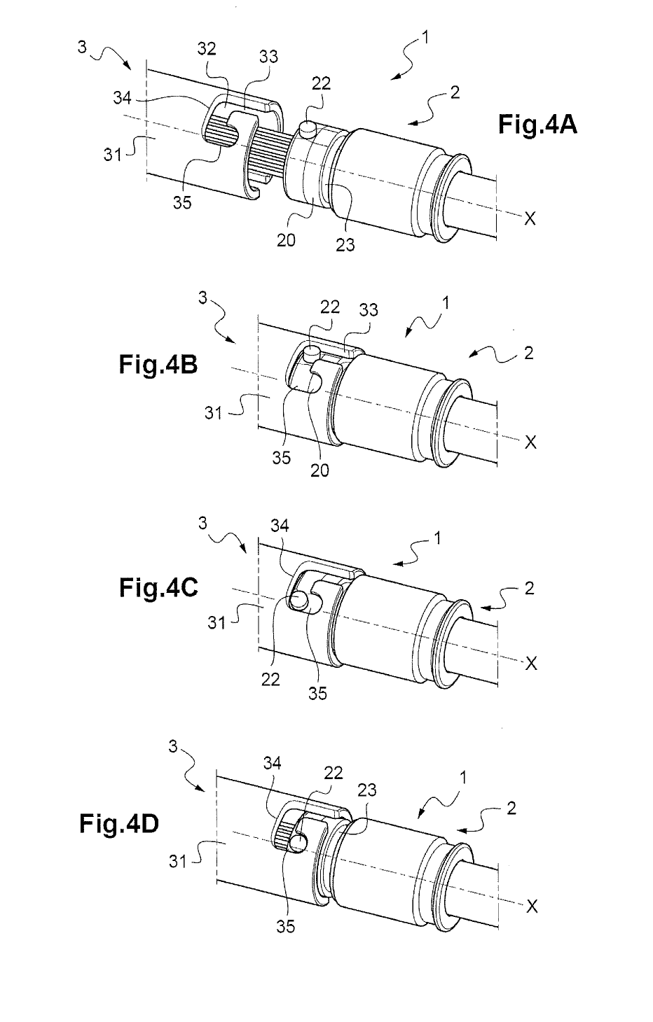

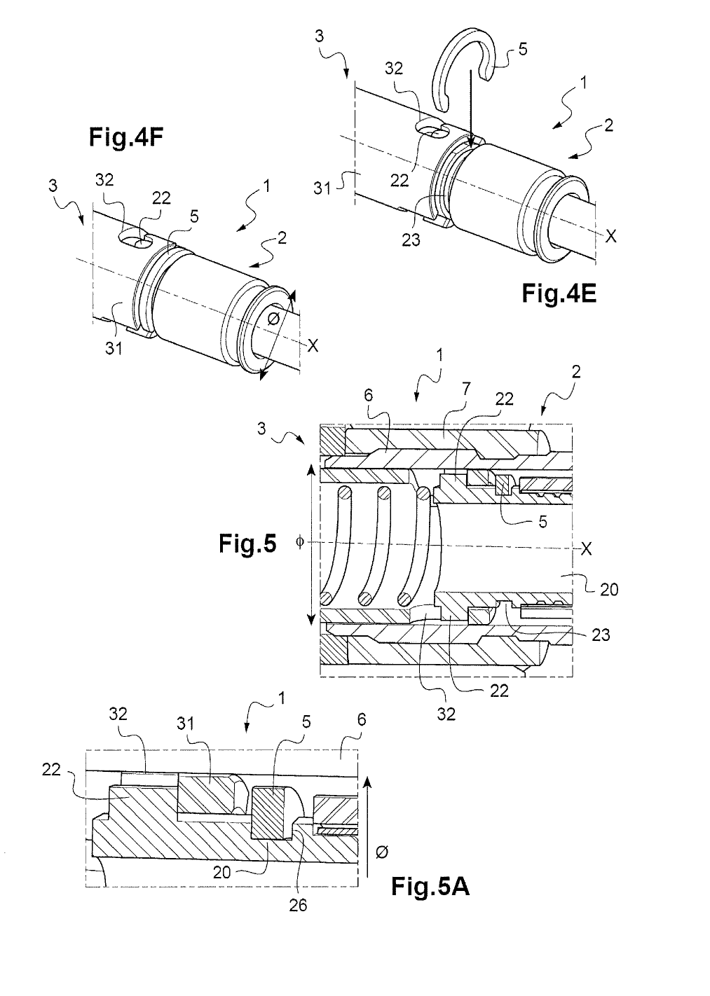

FIGS. 4A to 4F are perspective views showing all of the steps of assembling a connection assembly, including the step of placing an immobilizing part in accordance with a second variant of the invention,

FIGS. 5 and 5A are respectively a view in longitudinal section and a detail view of a connection assembly with an immobilizing part in accordance with the second variant of the invention and sealing elements,

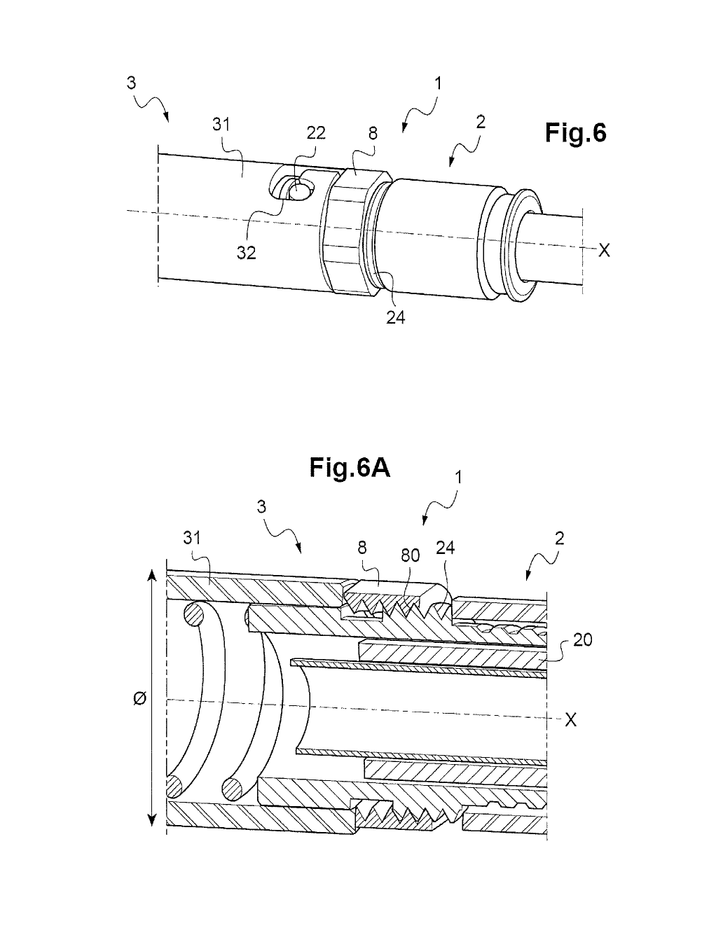

FIGS. 6 and 6A are respectively a perspective view and a sectional detail view of another connection assembly with an immobilizing part in accordance with a third variant of the invention and sealing elements,

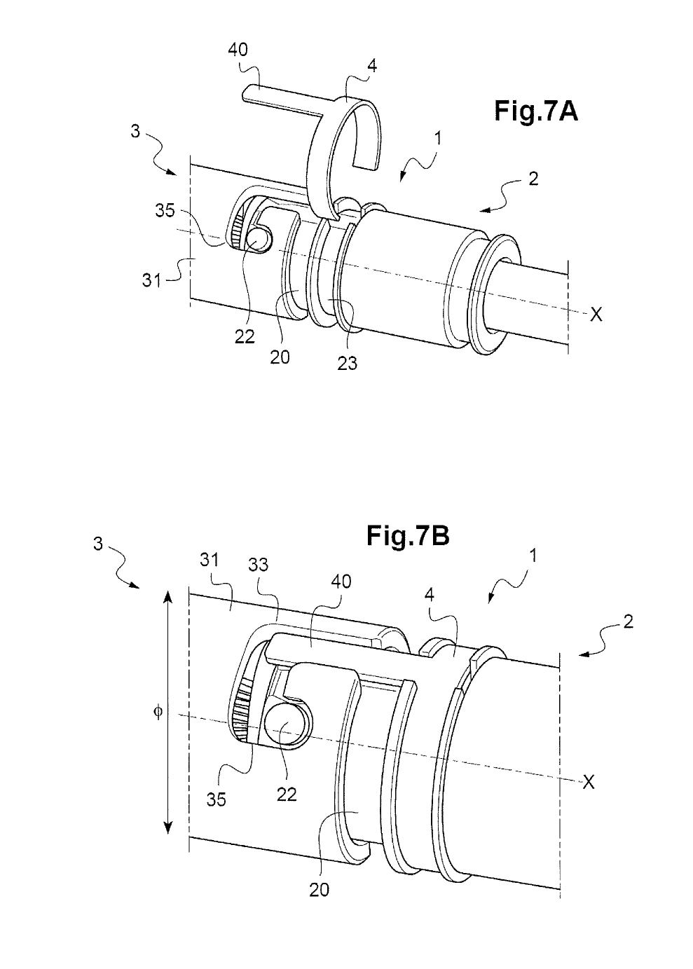

FIGS. 7A and 7B are perspective views showing the step of placing an immobilizing part in accordance with a fourth variant of the invention on a connection assembly like that shown in FIGS. 4A to 4F.

For clarity, the same elements of a prior art connection assembly and of a connection assembly in accordance with the invention are designated by the same reference numbers.

FIG. 1 has already been described in the preamble. It will therefore not be described again hereinafter.

There is shown in FIGS. 2A to 2C the step of removably placing an elastic ring 4 of constant section constituting the part immobilizing the locking cap 31 against movement in translation.

To be more precise, when the lug 22 is lodged in the abutment portion 35 of the groove 32, the connector 2 and the connector 3 are in their position of mutual locking (FIG. 2A).

The elastic ring 4 is then mounted directly on the bearing surface 21 of the body 20 of the connector 2 perpendicularly to the axis X of the connection and therefore immobilizes the cap 31 against movement in translation along the axis X of the connection (FIG. 2B). In other words, the cap 31 cannot be moved in translation in the direction of the arrow in FIG. 2C, the consequence of which is to maintain the mutual locking.

The elastic ring 4 cannot be removed unintentionally by an operator because they must insert a tool, typically a screwdriver, between the ring 4 and its bearing surface 21 to remove it.

Moreover, as can be seen in FIG. 2C, the overall size in the radial direction of the elastic ring 4 of constant section is such that it does not project beyond the diameter of the locking cap 31. The initial overall size of the known connection assembly from FIG. 1 is therefore not modified, which notably makes it possible to cover the cap 31 with a sealing sleeve without it being necessary to make any modification to it,

There is shown in FIGS. 3A and 3B another connection assembly, in the connected and locked configuration of which an elastic ring 4 of constant section is also placed on a bearing surface 21 of the cylindrical body 20 to prevent the movement in translation of the locking element 31. The connection element 2 carrying the lug 22 is in the example shown here an optical contact element conforming to the NF EN 4531 standard, and the other connection element 3 constitutes the cavity adapter of the insert of a multi-contact connector.

The portion of the multi-contact connector 3 includes a housing 31 in which the locking groove 32 is formed. Accordingly, in the position of mutual locking the contact element 2 is locked in the housing 31 (FIG. 3A). Placing the elastic ring 4 of constant section on the bearing surface 21 makes it possible to prevent any relative movement in translation between the contact element 2 and the housing 31 of the multi-contact connector portion (FIG. 3B), which therefore prevents any unintentional unlocking between them.

All of the steps of assembling another connection assembly are described now with reference to FIGS. 4A to 4F, including the step of placing in a groove 23 a ring 4 of crescent shape type constituting a variant of the elastic ring 4 of constant section shown in FIGS. 2A to 3B.

In the example shown here, the connection element 2 is a quadri-axial contact element and the connection element 3 is a portion of a multi-contact connector of which a housing portion 31 for the contact 2 constitutes the locking element.

First the contact element 2 is positioned on the axis of the housing portion 31 with the lug 22 aligned with the rectilinear portion 33 (FIG. 4A).

Then relative movement in translation between the contact element 2 and the housing portion 31 is effected until the lug 22 abuts against the end of the portion 33 of the groove 32 (FIG. 4B),

This movement in translation is effected in a direction of connection of the connection elements 2, 3.

Relative rotation between the contact element 2 and the housing 31 is then effected until the lug 22 abuts against the end of the transverse portion 34 of the groove 32 (FIG. 4C).

A final relative movement in translation between the contact element 2 and the housing 31 but in the opposite direction to the initial movement is then effected until the lug 22 abuts against the end of the rectilinear portion 35 of the groove 32 (FIG. 4D).

This second movement in translation is effected in a direction of disconnection of the connection elements 2, 3.

In this position from FIG. 4D, the contact element 2 and the multi-contact connector portion 3 are locked together.

A crescent-shaped ring 5 is then placed at the bottom of a groove 23 formed on the body 20 of the contact element 2 carrying the lug 22 (FIG. 4E).

The ring 5 so placed therefore makes it possible to prevent any relative movement in translation between the contact element 2 and the housing 31 of the multi-contact connector portion (FIG. 4F), which therefore prevents all risk of unintentional unlocking between them.

Moreover, as can be seen in this FIG. 4F, the ring 5 does not project from the dimensioning diameter 0 of the housing 31.

FIGS. 5 and 5A illustrate the advantage of having the immobilizing ring 5 not project beyond the largest outside diameter of the locking element 31 carrying the groove 32.

This small overall size in the radial direction of the immobilizing ring makes it possible to place a sealing sleeve 6 directly around the locking element 31. A good seal of the connection assembly is obtained in this way without modification of the sealing parts 6, 7. In other words, placing the part 5 immobilizing movement in translation of the locking element 31 does not involve any modification of the parts 6, 7 necessary for the production of the connection assembly 1.

There is shown in FIGS. 6 and 6A a variant part for immobilizing the locking element 31 against movement in translation. Here this is a nut 8 the interior thread 80 of which is screwed onto the exterior thread 24 of the body 20 carrying the locking lug, once the mutual locking has been effected. The nut 8 can therefore move longitudinally in translation, which renders it removable.

As can be seen in FIG. 6A, the nut 8 is screwed on until it comes into longitudinal abutment along the axis of the connection assembly 1 against the locking element 31.

As can also be seen in this FIG. 6A, the outside diameter of the nut 8 is chosen so as not to project beyond the outside diameter of the locking element 31.

There is shown in FIGS. 7A and 7B the placing of another variant ring 4 for immobilizing the locking element 31 against movement in translation.

Here the ring 4 of constant section includes a tab 40 that extends the constant section. On placing the ring 4 in the groove 23 by its constant section, this tab 40 comes to be lodged inside the rectilinear portion 33 of the groove 32 via which the locking lug 22 is introduced (FIG. 7B).

Accordingly, in the event of attempted movement in translation or in rotation relative to the contact element 2 of the locking element 31, the tab 40 immobilizes the latter.

The invention is not limited to the examples that have just been described.

The invention makes it possible to offer a solution for immobilizing movement in translation additional to the bayonet locking of known connection assemblies, which prevents all risk of accidental unlocking and therefore all risk of disassembling or even of disconnection between the connection elements,

1. Connection assembly including:
a first connection element,
a second connection element,
a system for mutual locking of the first and second connection elements, the system including at least one locking lug at the periphery of the body of one of the first and second connection elements and a locking element integral to the other of the first and second connection elements, including at least one locking groove the shape and the arrangement of which are such that the lug can penetrate into it by movement in translation relative to the lug of the locking element and thereafter rotation of the latter around the body carrying the lug effects the mutual locking,
wherein it further includes a part for immobilizing the locking element against movement in translation in the position of mutual locking, the immobilizing part being removably placed on the body carrying the lug.

2. Connection assembly according to claim 1, wherein the immobilizing part is adapted to immobilize the locking element against movement in translation in a direction of connection of the first and second connection elements.

3. Connection assembly according to claim 1, wherein when it is in its immobilizing position, the part does not project beyond the dimensioning diameter of the locking system.

4. Connection assembly according to claim 3, wherein when it is in its immobilizing position, the immobilizing part does not project beyond the largest outside diameter Ø of the locking element.

5. Connection assembly according to claim 1, wherein the immobilizing part is an elastic ring mounted directly or indirectly on a cylindrical bearing surface of the body carrying the lug.

6. Connection assembly according to Claim 5, wherein the elastic ring is mounted in a groove of the body carrying the lug.

7. Connection assembly according to claim 5, wherein the elastic ring is mounted perpendicularly to the axis of the connection.

8. Connection assembly according to claim 5, wherein the elastic ring is a snap ring of constant section.

9. Connection assembly according to claim 8, wherein the snap ring of constant section further includes a tab lodged in the part of the locking groove in which the lug is inserted during the movement in translation of the locking element and that it open to the outside.

10. Connection assembly according to claim 5, wherein the elastic ring is a ring of non-constant section.

11. Connection assembly according to claim 1, wherein the locking part is a nut the interior thread of which is screwed onto the exterior thread of the body carrying the lug.

12. Connection assembly according to claim 1, wherein one of the first and second connection elements is of female type, whereas the other is of male type, adapted to be connected to the female connection element, and in that the locking element constitutes a cap mounted so as to be free to rotate and to move in translation around the body of one of the female or male connection elements.

13. Connection assembly according to claim 12, wherein it constitutes a coaxial connection assembly, intended to connect two coaxial cables to each other, each of the connection elements constituting a coaxial connector.

14. Connection assembly according to claim 12, wherein one of the first and second connection elements constitutes a part of a multi-contact connector, whereas the other carrying the locking lug constitutes an optical contact element of the connector.

15. Connection assembly according to claim 1, wherein it constitutes a connection assembly with electrical and/or optical contacts.

16. Method of assembling two connection elements, respectively male and female, of a connection assembly further including a system for locking the connection elements in a configuration connected to each other, the system including at least one locking lug at the periphery of the body of one of the male or female connection elements and a locking element, referred to as the locking cap, mounted so as to be free to rotate and around the body of the other of the connection elements, and including at least one locking groove, the method including the following steps:
connecting the connection elements to each other mutual locking of the elements in their connected configuration by movement in translation of the cap so that the lug can penetrate into the groove by movement in translation of the cap followed by rotation thereof about the body carrying the lug, removably placing an immobilizing part on the body carrying the lug so that it immobilizes against movement in translation the cap in the position of mutual locking.

17. Method of disassembling two connection elements, respectively male and female of a connection assembly further including a system for locking the connection elements in a configuration connected to each other, the system including at least one locking lug at the periphery of the body of one of the connection elements, and a locking element, referred to as the locking cap, mounted so as to be free to rotate and around the body of the other of the connection elements, and including at least one locking groove, the method including the following steps:
removing a removable immobilizing part on the body carrying the lug from its immobilizing position in which it immobilizes the cap against movement in translation in the position of mutual locking of the elements,
mutual unlocking of the elements in their connected configuration by rotation of the cap about the body carrying the lug followed by movement in translation such that the lug can be extracted from the groove,
disconnecting the connection elements from each other.
